(19) United States
(12) Patent Application Publication
(10) Pub. No.: US 2012/0011454 A1
(43) Pub. Date: Jan. 12, 2012

(54) Method and system for intelligently mining data during communication streams to present context-sensitive advertisements using background substitution

(75) Inventors: Timothy Droz, San Jose, CA (US); Sunil Acharya, San Jose, CA (US); Cyrus Bamji, Fremont, CA (US)

(73) Assignee: Microsoft Corporation

(21) Appl. No.: 12/387,438

(22) Filed: Apr. 30, 2009

Related U.S. Application Data
(60) Provisional application No. 61/126,005, filed on Apr. 30, 2008.

(51) Int. Cl. G06F 3/00

(52) U.S. Cl. 715/758

(57) ABSTRACT

The present invention mines or extracts data present during interaction between at least two participants, for example in a chat session, a video session, etc. via the Internet. The data, which can include participant web camera generated video, audio, keyboard typed information, handwriting recognized information, is analyzed. Based upon the analysis, content-dependent information is determined and may be displayed to one or more participants in the chat session. In one aspect, a video foreground based upon a participant's generated video is combined with a customized computer generated background that is based upon data mined from the chat session. The customized background preferably is melded seamlessly with the participant's foreground data, preferably via background substitution that combines RGB video with depth data that predicts what background may substituted with new imagery. Content-based targeted information can include advertisement(s).

### RELATIONSHIP TO CO-PENDING APPLICATION

Priority is claimed to co-pending U.S. provisional patent application Ser. No. 61/126,005 filed 30 Apr. 2008 entitled Method and System for Intelligently Mining Data During Video Communications to Present Context-Sensitive Advertisements Using Background Substitution”, which application is assigned to Canesta, Inc., assignee herein.

### FIELD OF THE INVENTION

The present invention relates generally to real-time communication streams, e.g., chat or teleconferencing sessions that typically include video but are not required to do so, and more specifically to mining of multimodal data in the communication streams for use in altering at least one characteristic of the stream. The altered stream can present (audibly and/or visually) new content that is related to at least some of the mined data.

### BACKGROUND OF THE INVENTION

Manipulation of video data is often employed in producing commercial films, but is becoming increasingly more important in other applications, including video streams available via the Internet, for example chat sessions that can include video. One form of video manipulation is the so-called green screen substitution, which motion picture and television producers use to create composite image special effects. For example, actors or other objects may be filmed in the foreground of a scene that includes a uniformly lit flat screen background having a pure color, typically green. A camera using conventional color film or an electronic camera with a sensor array of red, green, blue (RGB) pixels captures the entire scene. During production, the background green is eliminated based upon its luminance, chroma and hue characteristics, and a new backdrop substituted, perhaps a blue sky with wind blown white clouds, a herd of charging elephants, etc. If the background image to be eliminated (the green screen) is completely known to the camera, the result is a motion picture (or still picture) of the actors in the foreground superimposed almost seamless in front of the substitute background. When done properly, the foreground images appear to superimpose over the substitute background. In general there is good granularity at the interface between the edges of the actors or objects in the foreground, and the substitute background. By good granularity it is meant that the foreground actors or objects appear to meld into the substitute background as though the actors had originally been filmed in front of the substitute background. Successful green screen techniques require that the green background be static, e.g., there be no discernable pattern on the green background such that any movement of the background relative to the camera would go undetected. But the relationship between camera and background must be static for backgrounds that have a motion-discernable pattern. If this static relationship between camera and background is not met, undesired results can occur such as portions of the foreground being incorrectly identified as background or vice versa.

Green screen composite imaging is readily implemented in a large commercial production studio, but can be costly and require a large staging facility, in addition to special processing equipment. In practice such imaging effects are typically beyond the reach of amateur video producers and still photographers.

It is also known in the art to acquire images using three-dimensional cameras to ascertain Z depth distances to a target object. Camera systems that acquire both RGB images and Z-data are frequently referred to as RGB-Z systems. With respect to systems that acquire Z-data, e.g., depth or distance information from the camera system to an object, some prior art depth camera systems approximate the distance or range to an object based upon luminosity or brightness information reflected by the object. But Z-systems that rely upon luminosity data can be confused by reflected light from a distant but shiny object, and by light from a less distant but less reflective object. Both objects can erroneously appear to be the same distance from the camera. So-called structured light systems, e.g., stereographic cameras, may be used to acquire Z-data. But in practice, such geometry based methods require high precision and are often fooled.

A more accurate class of range or Z distance systems are the so-called time-of-flight (TOF) systems, many of which have been pioneered by Canesta, Inc., assignee herein. Various aspects of TOF imaging systems are described in the following patents assigned to Canesta, Inc.: U.S. Pat. No. 7,203,356 “Subject Segmentation and Tracking Using 3D Sensing Technology for Video Compression in Multimedia Applications”, U.S. Pat. No. 6,906,793 Methods and Devices for Charge Management for Three-Dimensional Sensing”, and U.S. Pat. No. 6,580,496 “Systems for CMOS-Compatible Three-Dimensional Image Sensing Using Quantum Efficiency Modulation”, U.S. Pat. No. 6,515,740 “Methods for CMOS-Compatible Three-Dimensional image Sensing Using Quantum Efficiency Modulation”.

FIG. 1 depicts an exemplary TOF system, as described in U.S. Pat. No. 6,323,942 entitled “CMOS-Compatible Three-Dimensional Image Sensor IC” (2001), which patent is incorporated herein by reference as further background material. TOF system 10 can be implemented on a single IC 110, without moving parts and with relatively few off-chip components. System 100 includes a two-dimensional array 130 of Z pixel detectors 140, each of which has dedicated circuitry 150 for processing detection charge output by the associated detector. In a typical application, array 130 might include 100×100 pixels 140, and thus include 100×100 processing circuits 150. IC 110 preferably also includes a microprocessor or microcontroller unit 160, memory 170 (which preferably includes random access memory or RAM and read-only memory or ROM), a high speed distributable clock 180, and various computing and input/output (I/O) circuitry 190. Among other functions, controller unit 160 may perform distance to object and object velocity calculations, which may be output as DATA.

Under control of microprocessor 160, a source of optical energy 120, typical IR or NIR wavelengths, is periodically energized and emits optical energy Si via lens 125 toward an object target 20. Typically the optical energy is light, for example emitted by a laser diode or LED device 120. Some of the emitted optical energy will be reflected off the surface of target object 20 as reflected energy S₂. This reflected energy passes through an aperture field stop and lens, collectively 135, and will fall upon two-dimensional array 130 of pixel detectors 140 where a depth or Z image is formed. In some implementations, each imaging pixel detector 140 captures time-of-flight (TOF) required for optical energy transmitted by emitter 120 to reach target object 20 and be reflected back for detection by two-dimensional sensor array 130. Using this TOF information, distances Z can be determined as part of the DATA signal that can be output elsewhere, as needed.

Emitted optical energy S₁ traversing to more distant surface regions of target object 20, e.g., Z3, before being reflected back toward system 100 will define a longer time-of-flight than radiation falling upon and being reflected from a nearer surface portion of the target object (or a closer target object), e.g., at distance Z1. For example the time-of-flight for optical energy to traverse the roundtrip path noted at t1 is given by t1=2·Z1/C, where C is velocity of light. TOF sensor system 10 can acquire three-dimensional images of a target object in real time, simultaneously acquiring both luminosity data (e.g., signal brightness amplitude) and true TOF distance (Z) measurements of a target object or scene. Most of the Z-pixel detectors in Canesta-type TOF systems have additive signal properties in that each individual pixel acquires a pair of data (i.e., a vector) in the form of luminosity information and also in the form of Z distance information. While the system of FIG. 1 can measure Z, the nature of Z detection according to the first described embodiment of the '942 patent does not lend itself to use with all embodiments of the present invention because the Z-pixel detectors do not exhibit a signal additive characteristic. A useful class of TOF sensor system is the so-called phase-sensing TOF system. Most current Canesta, Inc. Z-pixel detectors operate with this characteristic.

Many Canesta, Inc. systems determine TOF and construct a depth image by examining relative phase shift between the transmitted light signals S₁ having a known phase, and signals S₂ reflected from the target object. Exemplary such phase-type TOF systems are described in several U.S. patents assigned to Canesta, Inc., assignee herein, including U.S. Pat. No. 6,515,740 “Methods for CMOS-Compatible Three-Dimensional Imaging Sensing Using Quantum Efficiency Modulation”, U.S. Pat. No. 6,906,793 entitled Methods and Devices for Charge Management for Three Dimensional Sensing, U.S. Pat. No. 6,678,039 “Method and System to Enhance Dynamic Range Conversion Useable With CMOS Three-Dimensional Imaging”, U.S. Pat. No. 6,587,186 “CMOS-Compatible Three-Dimensional Image Sensing Using Reduced Peak Energy ”, U.S. Pat. No. 6,580,496 “Systems for CMOS-Compatible Three-Dimensional Image Sensing Using Quantum Efficiency Modulation”

FIG. 2A is based upon above-noted U.S. Pat. No. 6,906,793 and depicts an exemplary phase-type TOF system in which phase shift between emitted and detected signals, respectively, S₁ and S₂ provides a measure of distance Z to target object 20. Under control of microprocessor 160, optical energy source 120 is periodically energized by an exciter 115, and emits output modulated optical energy assumed here for simplicity to be modeled by S₁=Sₒᵤₜ=cos(ωt) having a known phase towards object target 20. Emitter 120 preferably is at least one LED or laser diode(s) emitting low power (e.g., perhaps 1 W) periodic waveform, producing optical energy emissions of known frequency (perhaps a few dozen MHz) for a time period known as the shutter time (perhaps 10 ms).

Some of the emitted optical energy (denoted Sₒᵤₜ) will be reflected (denoted S₂=Sᵢₙ) off the surface of target object 20, and will pass through aperture field stop and lens, collectively 135, and will fall upon two-dimensional array 130 of pixel or photodetectors 140. When reflected optical energy Sᵢₙ impinges upon photodetectors 140 in array 130, photons within the photodetectors are released, and converted into tiny amounts of detection current. For ease of explanation, outgoing and incoming optical energy may be modeled as Sₒᵤₜ=cos(ω·t), and Sᵢₙ=A·cos(ω·t+θ) respectively, where A is a brightness or intensity coefficient, ω·t represents the periodic modulation frequency, and θ is phase shift. As distance Z changes, phase shift θ changes, and FIGS. 2B and 2C depict a phase shift θ between emitted and detected signals, S₁, S₂. The phase shift θ data can be processed to yield desired Z depth information. Within array 130, pixel detection current can be integrated to accumulate a meaningful detection signal, used to form a depth image. In this fashion, TOF system 100 can capture and provide Z depth information at each pixel detector 140 in sensor array 130 for each frame of acquired data.

In preferred embodiments, pixel detection information is captured at at least two discrete phases, preferably 0° and 90°, and is processed to yield Z data.

System 100 yields a phase shift θ at distance Z due to time-of-flight given by:

θ=2·ω·Z/C=2·(2·π·f)·Z/C (1)

where C is the speed of light, 300,000 Km/sec. From equation (1) above it follows that distance Z is given by:

Z=θ·C/2·ω=θ·C/(2·2·f·π) (2)

And when θ=2·π, the aliasing interval range associated with modulation frequency f is given as:

Z_{AIR}=C/(2·f) (3)

In practice, changes in Z produce change in phase shift θ although eventually the phase shift begins to repeat, e.g., θ=θ+2·π, etc. Thus, distance Z is known modulo 2·π·C/2·ω)=C/2·f, where f is the modulation frequency.

Canesta, Inc. has also developed a so-called RGB-Z sensor system, a system that simultaneously acquires both red, green, blue visible data, and Z depth data. FIG. 3 is taken from Canesta U.S. patent application Ser. No. 11/044,996, publication no. US 2005/0285966, entitled “Single Chip Red, Green, Blue, Distance (RGB-Z) Sensor”. FIG. 3A is taken from Canesta's above-noted '966 publication and discloses an RGB-Z system 100′. System 100′ includes an RGB-Z sensor 110 having an array 230 of Z pixel detectors, and an array 230′ of RGB detectors. Other embodiments of system 100′ may implement an RGB-Z sensor comprising interspersed RGB and Z pixels on a single substrate. In FIG. 3A, sensor 110 preferably includes optically transparent structures 220 and 240 receive incoming optical energy via lens 135, and split the energy into IR-NIR or Z components and RGB components. In FIG. 3A, the incoming IR-NIR Z components of optical energy S2 are directed upward for detection by Z pixel array 230, while the incoming RGB optical components pass through for detection by RGB pixel array 230′. Detected RGB data may be processed by circuitry 265 to produce an RGB image on a display 70, while Z data is coupled to an omnibus block 235 that may be understood to include elements 160, 170, 180, 190, 115 from FIG. 2A.

System 100′ in FIG. 3A can thus simultaneously acquire an RGB image, preferably viewable on display 70. FIG. 3A depicts an exemplary RGB-Z system 100′, as described in the above-noted Canesta '966 publication. While the embodiment shown in FIG. 3A uses a single lens 135 to focus incoming IR-NIR and RGB optical energy, other embodiments depicted in the Canesta '966 disclosure use a first lens to focus incoming IR-NIR energy, and a second lens, closely spaced near the first lens, to focus incoming RGB optical energy. Referring to FIG. 3A, system 100′ includes an RGB-Z sensor 110 having an array 230 of Z pixel detectors 240, and an array 230′ of RGB detectors 240′. Other embodiments of system 100′ may implement an RGB-Z sensor comprising interspersed RGB and Z pixels on a single substrate. In FIG. 3A, sensor 110 preferably includes optically transparent structures 220 and 240 receive incoming optical energy via lens 135, and split the energy into IR-NIR or Z components and RGB components. In FIG. 3A, the incoming IR-NIR Z components of optical energy S2 are directed upward for detection by Z pixel array 230, while the incoming RGB optical components pass through for detection by RGB pixel array 230′. Detected RGB data may be processed by circuitry 265 to produce an RGB image on a display 70, while Z data is coupled to an omnibus block 235 that may be understood to include elements 160, 170, 180, 190, 115 from FIG. 2A.

FIG. 3B depicts a single Z pixel 240, while FIG. 3C depicts a group of RGB pixels 240′. While FIGS. 3B and 3C are not to scale, in practice the area of a single Z pixel is substantially greater than the area of an individual RGB pixel. Exemplary sizes might be 15 μm×15 μm for a Z pixel, and perhaps 4 μm×4 μm for an RGB pixel. Thus, the resolution or granularity for information acquired by RGB pixels is substantially better than information acquired by Z pixels. This disparity in resolution characteristics substantially affects the ability of RGB-Z system to be used successfully to provide video effects.

FIG. 4A is a grayscale version of an image acquired with an RGB-Z system, and shows an object 20 that is a person whose right arm is held in front of the person's chest. Let everything that is “not” the person be deemed background 20′. Of course the problem is to accurately discern where the edges of the person in the foreground are relative to the background. Arrow 250 denotes a region of the forearm, a tiny portion of which is shown at the Z pixel level in FIG. 4B. The diagonal line in FIG. 4B represents the boundary between the background (to the left of the diagonal line), and an upper portion of the person's arm, shown shaded to the right of the diagonal line. FIG. 4B represents many RGB pixels, and fewer Z pixels. One Z pixel is outlined in phantom, and the area of the one Z pixel encompasses nine smaller RGB pixels, denoted RGB1, RGB2, . . . RGB9.

In FIG. 4B, each RGB pixel will represent a color. For example if the person is wearing a red sweater, RGB3, RGB5, RGB6, RGB8, RGB9 should each be red. RGB1 appears to be nearly all background and should be colored with whatever the background is. But what color should RGB pixels RGB2, RGB4, RGB7 be? Each of these pixels shares the same Z value as any of RGB1, RGB2, . . . RGB9. If the diagonal line drawn is precisely the boundary between foreground and background, then RGB1 should be colored mostly with background, with a small contribution of foreground color. By the same token, RGB7 should be colored mostly with foreground, with a small contribution of background color. RGB4 and RGB2 should be fractionally colored about 50% with background and 50% with foreground color. But the problem is knowing where the boundary line should be drawn. Many prior art techniques make it difficult to intelligently identify the boundary line, and the result can be a zig-zag boundary on the perimeter of the foreground object, rather than a seamlessly smooth boundary. If a background substitution effect were to be employed, the result could be a foreground object that has a visibly jagged perimeter, an effect that would not look realistic to a viewer.

However the present invention can function with many three-dimensional sensor systems whose performance characteristics may be inferior to those of true TOF systems. Some three-dimensional systems use so-called structured light, e.g., the above-cited U.S. Pat. No. 6,710,770, assigned to Canesta. Other prior art systems attempt to emulate three-dimensional imaging using two spaced-apart stereographic cameras. However in practice the performance of such stereographic systems is impaired by the fact that the two spaced-apart cameras acquire two images whose data must somehow be correlated to arrive at a three-dimensional image. Further, such systems are dependent upon luminosity data, which can often be confusing, e.g., distance bright objects may appear to be as close to the system as nearer gray objects.

Thus there is a need for real-time video processing systems and techniques that can acquire three-dimensional data and provide intelligent video manipulation. Preferably such a system would examine data including at least one of video, audio, and text, and intelligently manipulate all or some of the data. Preferably such a system should retain foreground video but intelligently replace background video with new content that depends on information mined from the video and/or audio and/or textual information in the stream of communication data. Such systems and techniques that operate well in the real world in real-time.

The present invention provides such systems and techniques, both in the context of three-dimensional systems that employ relatively inexpensive arrays of RGB and Z pixels, and for other three-dimensional imaging systems as well.

### SUMMARY OF THE INVENTION

Embodiments of the present invention provide methods and systems to mine or extract data present during interaction between at least two participants, for example in a communications stream, perhaps a chat or a video session, via the Internet or other transmission medium. The present invention analyzes the data and can create displayable content for viewing by one or more chat session participants responsive to the data. Without limitation, the data from at least one chat session participant includes a characteristic of a participant that can include web camera generated video, audio, keyboard typed information, handwriting recognized information, user-made gestures, etc. The displayable content may be viewed by at least one of the participants and preferably by all. Thus while several embodiments of the present invention are described with respect to mining video data, the data mined can be at least one of video, audio, writing (keyboard entered to hand generated), and gestures, without limitation. Thus the term video chat session can be understood to include a chat session in which the medium of exchange includes at least one of the above-enumerated data.

In one aspect, the present invention combines a video foreground based upon a participant's generated video, with a customized computer generated background that preferably is based upon data mined from the video chat session. The customized background preferably is melded seamlessly with the participant's foreground data, and can be created even in the absence of a video stream from the participant. Such melding can be carried out using background substitution, preferably by combining video information using both RGB or grayscale video and depth video, acquired using a depth camera. In one aspect, the background video includes targeted content such as an advertisement whose content is related to data mined from at least one of the participants in the chat session.

Preferably a participant's foreground video has a transparency level greater than 0%, and is scalable independently of size of the computer generated background. This computer generated background may include a virtual whiteboard useable by a participant in the video chat, or may include an advertisement with participant-operable displayed buttons. Other computer generated background information may include an HTML page, a video stream, a database with image(s), including a database with social networking information. Preferably this computer controlled background is updatable in real-time responsive to at least one content of the video chat. Preferably this computer controlled background can provide information of events occurring substantially contemporaneously with the video chat.

Other features and advantages of the invention will appear from the following description in which the preferred embodiments have been set forth in detail, in conjunction with the accompany drawings.

### BRIEF DESCRIPTION OF THE DRAWINGS

FIG. 1 depicts a time-of-flight (TOF) range finding system, according to the prior art;

FIG. 2A depicts a phase-based TOF range finding system whose Z-pixels exhibit additive signal properties, according to the prior art;

FIGS. 2B and 2C depict phase-shifted signals associated with the TOF range finding system of FIG. 2A, according to the prior art;

FIG. 3A depicts an omnibus RGB-Z range finding system, according to Canesta, Inc.'s published co-pending patent application US 2005/0285966;

FIGS. 3B and 3C depict respectively the large area and relatively small area associated with Z pixels, and with RGB pixels;

FIG. 4A is a grayscale version of a foreground subject and scene background, as acquired by an RGB-Z range finding system, with which the present invention may be practiced;

FIG. 4B depicts a portion of the foreground subject and a portion of the scene background of FIG. 4A, shown in detail at a Z pixel resolution;

FIG. 5 depicts an omnibus RGB-Z imaging system, according to embodiments of the present invention;

FIG. 6 depicts a generic three-dimensional system of any type, according to embodiments of the present invention;

FIG. 7 depicts three systems and associated monitors/computers whose data streams are coupled to each other via a communications medium such as the Internet, according to embodiments of the present invention; and

FIGS. 8-10 depict intelligent data mining and manipulation of background video in communication streams, according to embodiments of the present invention.

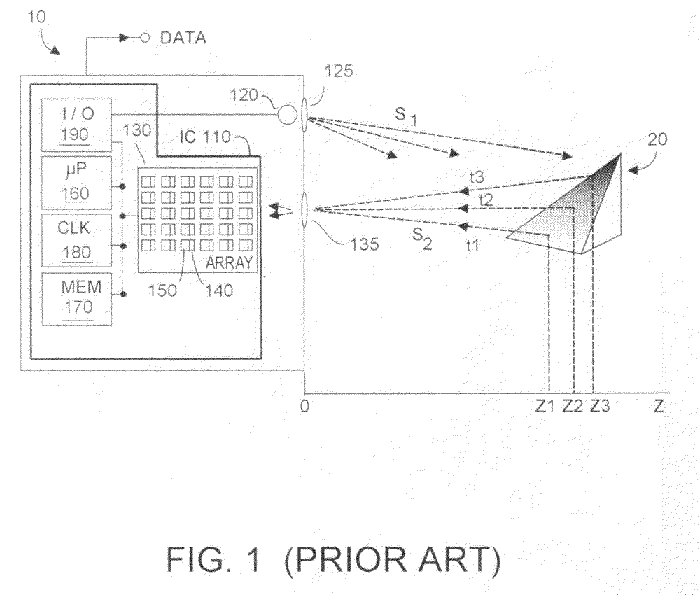

### DESCRIPTION OF THE PREFERRED EMBODIMENTS

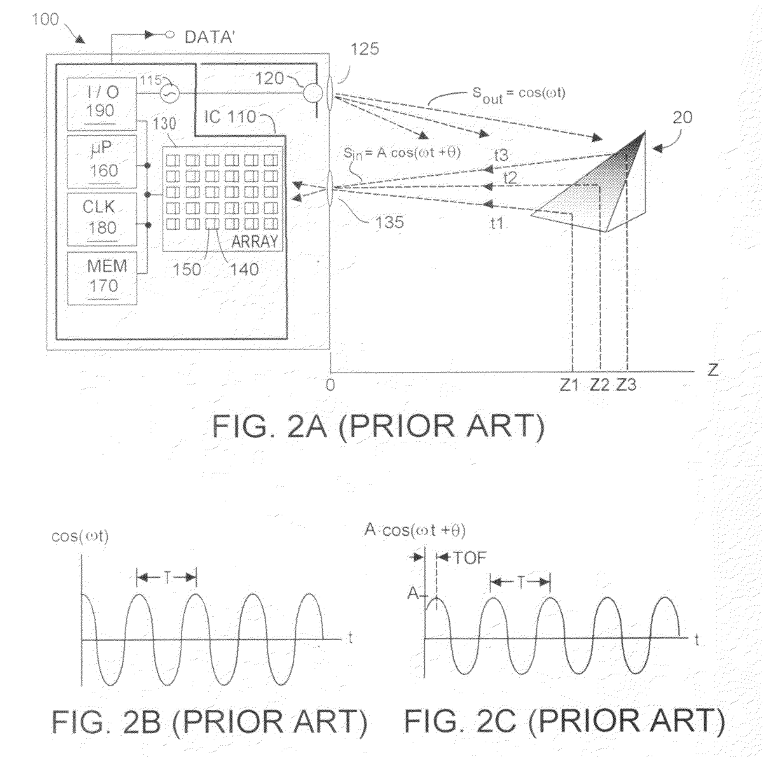

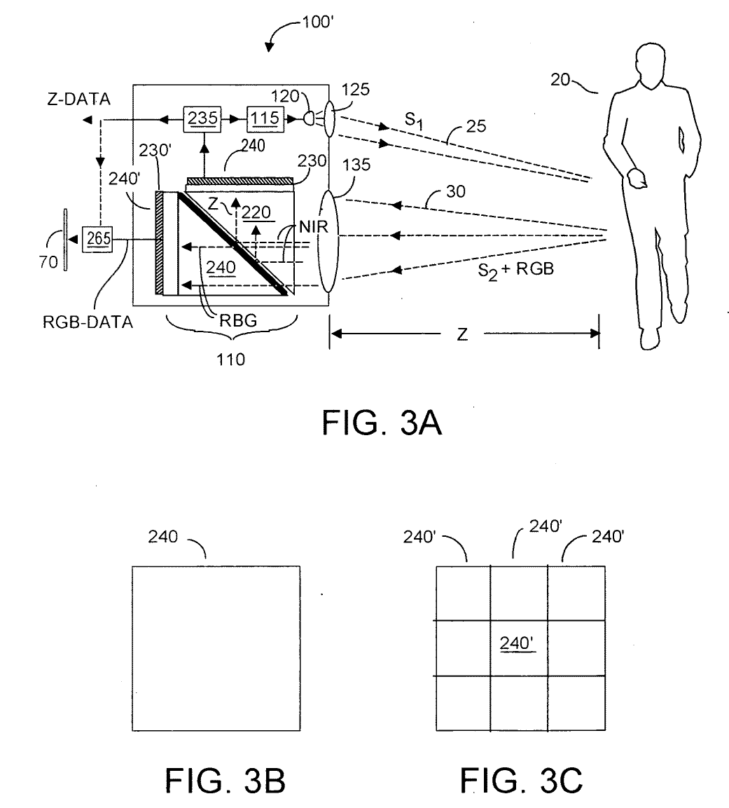

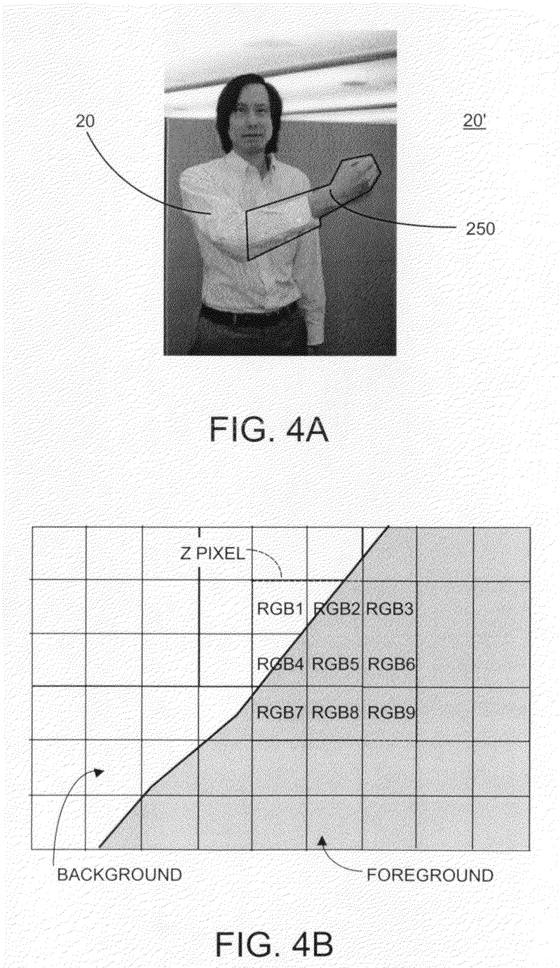

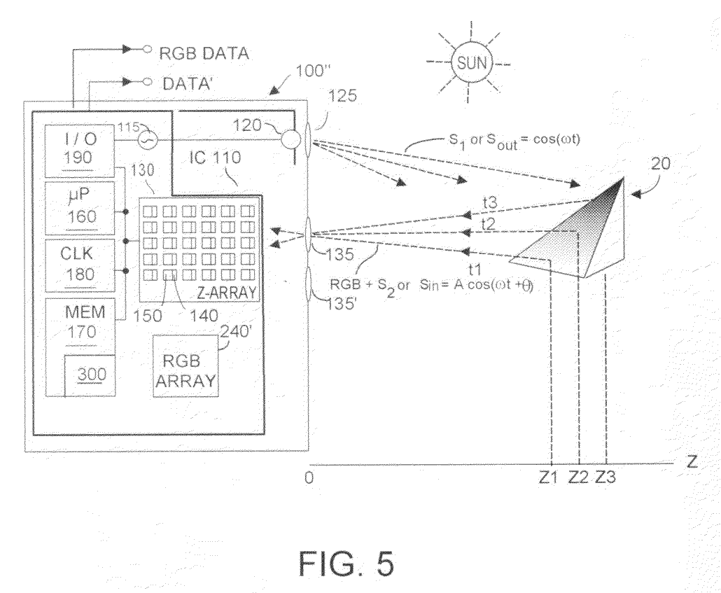

Aspects of the present invention may be practiced with image acquisition systems that acquire only Z data, and/or RGB data. In embodiments where RGB and Z data are used, the system that acquires RGB data need not be part of the system that detects Z data. FIG. 5 depicts an omnibus RGB-Z system 100″ that combines TOF functionality with Z-pixels as described with respect to FIG. 2A herein, with RGB and Z functionality as described with respect to FIG. 3A herein. In its broadest sense, RGB-Z system 100″ includes an array 130 of Z pixels 140, and includes an array 240′ of RGB pixels. It is understood that array 130 and array 240′ may be formed on separate substrates, or that a single substrate containing arrays of linear additive Z pixels and RGB pixels may be used. It is also noted that a separate lens 135′ may be used to focus incoming RGB optical energy. Memory 170 may be similar to that in FIG. 2A, and in the embodiment of FIG. 5, preferably stores a software routine 300 that when executed, by processor 160 or other processing resource (not shown) carries out algorithms implementing the various aspects of the present invention. System 100″ may be provided as part of a so-called web-camera (webcam), to acquire in real-time both a conventional RGB image of a scene 20, as well as a three-dimensional image of the same scene. In its simplest form, the three-dimensional acquired data can be used to discern foreground in the scene from background, e.g., background will be farther away (perhaps distance>Z2), whereas foreground will be closer to the system (perhaps distance<Z2). Routine 300, executable by processor 160 (or other processor) can thus determine what portions of the three-dimensional image are foreground vs. background, and within the RGB can cause image regions determined from Z-data to be background to be subtracted out. Sampling techniques can be applied at the interface of foreground and background images to reduce so-called zig-zag artifacts. Further details as to such techniques may be found in co-pending U.S. utility patent application Ser. No. 12/004,305, filed 11 Jan. 2008, entitled Video Manipulation of Red, Green, Blue, Distance (RGB-Z) Data Including Segmentation, Up-Sampling, and Background Substitution Techniques, which application is assigned to Canesta, Inc., assignee here.

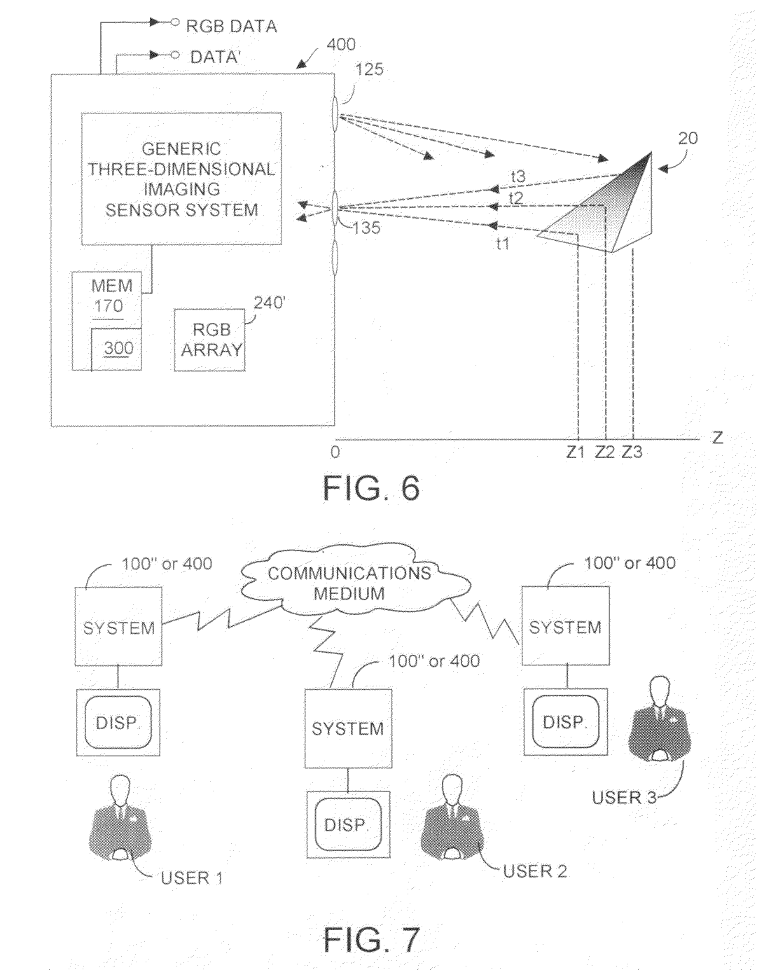

While range finding systems incorporating TOF techniques, as exemplified by system 100″ in FIG. 5 are especially suited to the present invention, as shown by FIG. 6, non-TOF systems 400 may instead be used, although degradation in performance may occur. For ease of illustration, let it be assumed that non-TOF system 400 includes an RGB array 240′, and memory 170 that includes an executable software routine 300 for carrying out aspects of the present invention.

FIG. 7 depicts a plurality of systems, which may be similar to TOF-enabled system 100″ (see FIG. 5) or generic system 400 (see FIG. 6). It is understood that each system can produce a data stream including at least one of (if not all) RGB video, audio, and text. Preferably each data stream includes at least one characteristic of the user or participant generating the data stream. Thus each system may include a webcam and/or a depth camera or depth system that produces a data stream, in this case a video stream, of the user associated with the specific system, a microphone to produce an audio stream generated by the system user, e.g., user 1, user 2, user 3, etc., a keyboard or the like to generate a text data stream. As used herein, the expression video stream or simply video is understood to encompass still image(s) or moving images captured by at least one of a conventional RGB or grayscale camera, and a depth camera, for example a Canesta-type three-dimensional sensing system. It is also understood that as used herein, the express video stream includes data processed from either or both of a RGB (or grayscale) and a depth camera or camera system. Thus, an avatar or segmented data may be encompassed by the term video or video stream. Associated with each system will be a video display (DISP.) that can show incoming video streams from other users, which video streams may already be segmented. For ease of illustration, FIG. 7 does not depict microphones, loud speakers, keyboards, but such input/out components preferably are present. The data streams are shown as zig-zag lightening-like lines coupling each system to a communications medium, perhaps the Internet, a LAN, a WAN, a cellular network, etc. The communications medium allows users to communicate with each other via incoming-outgoing data streams that can comprise any or all of video, audio, and text content. If desired, data streams could be telephonically generated conversations, whose contents are mined to arrive at at least one characteristic for each user participant in the telephonic communications session or chat.

Embodiments of the present invention utilize background substitution, which substitution may be implemented in any number of ways, such that although the background may be substituted, important and relevant information in the foreground image is preserved. In various embodiments, the foreground and/or background images may be derived from a real-time video stream, for example a video stream associated with a chat or teleconferencing session in which at least two users can communicate via the Internet, a LAN, a WAN, a cellular network, etc. In the example of a telephonic communications session or chat, enunciated sounds and words could be mined. Thus if one participant said “I am hungry”, a voice could come into the chat and enunciate “if you wish to order a pizza, dial 123-4567 or perhaps “press 1”, etc.

Commercial enterprises such as Google™ mail insert targeted advertisements in an email based on perceived textual content of the email. Substantial advertising revenue is earned by Google as a result. Embodiments of the present invention intelligently mine data streams associated with chat sessions and the like, e.g., video data and/or audio data and/or textual data, and then alter the background image seen by participants in the chat session to present targeted advertising. In embodiments of the present invention, the presented advertising is interactive in that a user can click or otherwise respond to the ad to achieve a result, perhaps ordering a pizza in response to a detected verbal, audio, textual, visual (including a recognized gesture) indicating hunger. Other useful data may be inserted into the information data stream responsive to contents of the information exchanged advertisements. Such other useful information may include the result of searches based on information exchanged or relevant data pertinent to the exchange.

In one embodiment, system 100″ or 400 includes known textual search infrastructures that can detect audio from a user's system, and then employ speech-to-text translation from the audio. The thus generated text is then coupled into a search engine or program similar to the Google™ mail program. Preferably most relevant fragments of the audio may be extracted so as to reduce queries to the search engine. With respect to FIGS. 5 and 6, it is assumed that software 300 includes or implements such textual search infrastructures, including speech-to-text translation from audio. Thus the present invention encompasses the use of data obtained in one domain, speech perhaps, that is processed in a second domain, text searching.

In some embodiments in which the chat session includes a video stream, a new background may be substituted responsive to information exchanged in the chat session. Such background may contain advertisements, branding, or other topics of interest relevant to the session. The foreground may be scaled (up or down or even distorted) so as to create adequate space for information to be presented in the background. The background may also be part of a document being exchanged during the chat or teleconferencing session such as a Microsoft Word™ document or Microsoft Powerpoint™ presentation. Because the foreground contains information that is meaningful to the users, user attention is focused on the foreground. Thus, the background is a good location in which to place information that is intelligently selected from aspects of the chat session data streams. Note that ad information if appropriate may also be overlaid over regions of the foreground, preferably over foreground regions deemed relatively unimportant.

The displayed video foreground may be scaled to fit properly in a background. For example a user's bust may be scaled to make the user look appropriate in a background that includes a conference table. In a video stream in which the foreground includes one or more users, user images may be replaced by avatars that can perform responsively to movements of the users they represent, e.g., if user number 1 raises the right hand to get attention, the displayed avatar can do likewise. Alternately the avatars may just be symbols representing a user participant, or more simply, symbols representing the status of the chat session.

As noted, preferably all modes of communication during the session may be intelligently mined for data. For example in a chat session whose communication stream includes textual chat, intelligent scanning of the textual data stream, the video data stream, and the audio data stream may be undertaken, to derive information. For example, if during the chat session a user types the word “pizza” or says the word “pizza” or perhaps points to an image of a pizza or makes a hunger-type gesture, perhaps rubbing the stomach, the present invention can target at least one, perhaps all user participants with an advertisement for pizza. The system may also keep track of which information came from which participant (e.g. who said what) to further refine its responses.

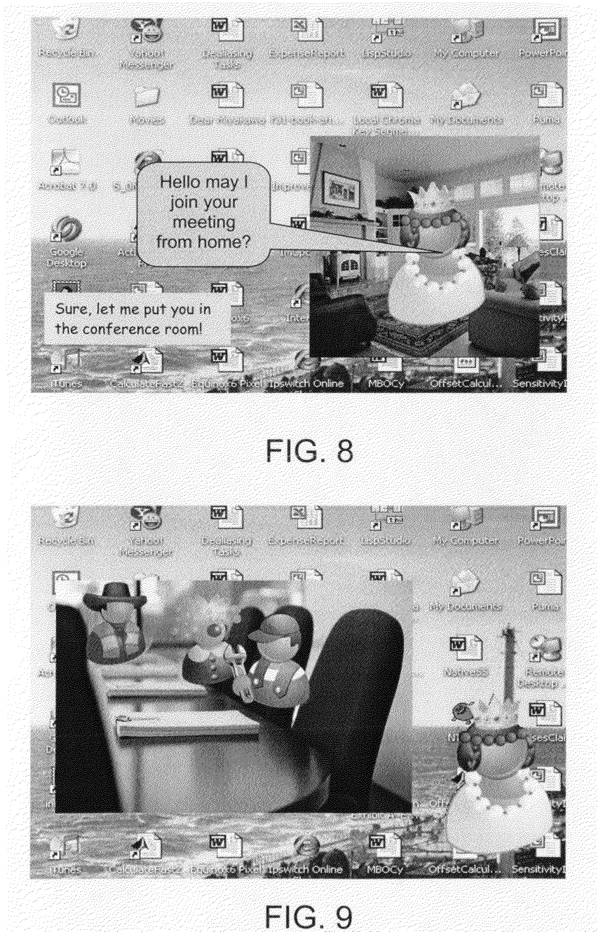

In one embodiment, the responses themselves may be placed in the text transfer stream, e.g., a pizza ad is placed into the text stream, or is inserted into the audio stream, e.g., an announcer reciting a pizza ad. In some embodiments, the background of the associated video stream is affected by action in the foreground, e.g., a displayed avatar jumps with joy and has a voice bubble spelling out, “I am hungry for Pizza”. It is understood that a computer controlled graphic output responsive to chat session may be implemented with or without the presence of a video stream. The computer controlled response is presented to at least one participant in the chat session, and may of course be presented to several if not to all participants. It is understood that each participant in the chat session may be presented with a different view of the session. Thus in various of FIGS. 8-12, one participant may view the clown next to the mechanics, whereas another participant may see these representations in a different order.

If desired, extraction of the foreground may be overlaid atop background with some transparency, which may be rendered in a manner known in the art, perhaps akin to rendering as in Windows Vista™. So doing allows important aspects of the background to remain visible to the users when the foreground is overlaid. In one embodiment, this overlay is implemented by making the foreground transparent. Alternatively, the foreground may be replaced by computer generated image(s) that preferably are controlled responsive to user foreground movements. Such control can be implemented by acquiring three-dimensional gesture information from the user participated using a three-dimensional sensor system or camera, as described in U.S. Pat. No. 7,340,077 (2008), entitled Gesture Recognition System Using Depth Perceptive Sensors, and assigned to Canesta, Inc., assignee herein. If desired, rather than appearing within its own window, the foreground or computer generated image may be placed directly on a desktop. In such embodiment, this imagery can be rendered in a fashion akin to Windows Word™ help assistants.

FIGS. 8-12 will now be described with respect to intelligently presenting targeted ads or other useful information into a chat or teleconferencing session between several user participants. In FIG. 8, a chat session (via the Internet or otherwise) is underway, but an additional person, presumably a female, wishes to join the session and communicates this verbally, textually, or otherwise to at least one (but not necessarily all) of the chat session participants. FIG. 8 depicts the video stream seen by at least one other chat session user already participating in the chat session, e.g., on their displays DISP. In FIG. 7. As shown in FIG. 8, participant video by the would-be joiner including her background is displayed on the system or computer desktop image. The lower portion of FIG. 8 shows the text or verbal response of one of the users already participating in the chat session, namely “sure, let me put you in the conference room!”.

In the displayed image of FIG. 9, the new user participant or one of the existing participants has turned on background substitution, in that the room space background seen in FIG. 8 is no longer present in FIG. 9. The user's image or avatar, preferably scaled, is shown moved into the conference room, and can appear directly on the desktop display seen by the other conference user participants. If desired, her image can be rendered partially transparent by the new user participant or by the other user participants already engaged in the chat session. Indeed the new participant can make herself transparent as well, if desired. In FIG. 9, the virtual conference room is de-iconified, which is to say it is displayed on the desktop, and represents the three other user participants already engaged in the on-going chat session. It is understood in FIG. 9 that the other three participants need not be a cowboy, a clown, or a mechanic. In FIG. 9, the displayed representation of the new user may be an actual image from the user's own webcam, or may be an extracted foreground from the user's video stream, or a computer generated avatar or icon that preferably is controlled responsive to the new user participant's movements.

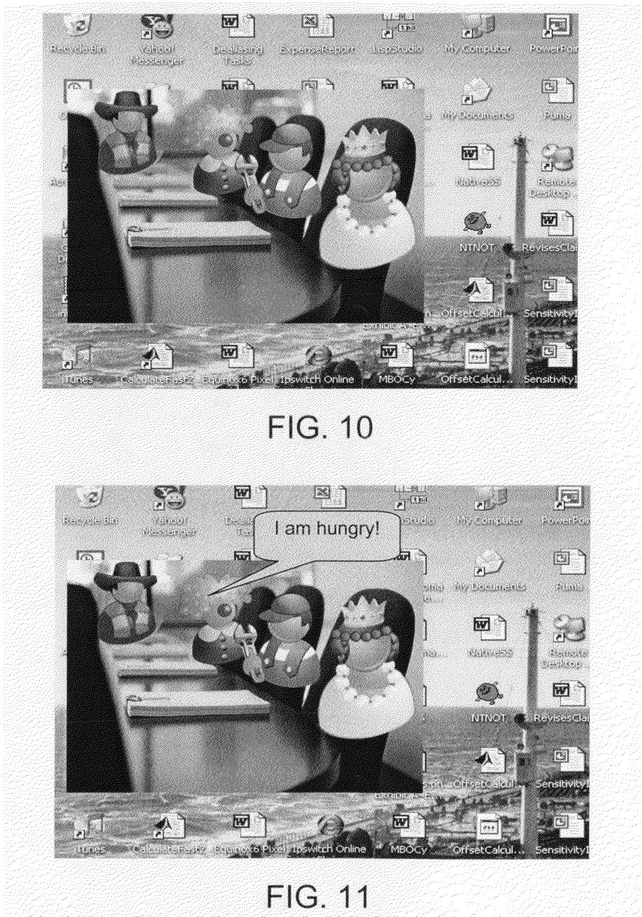

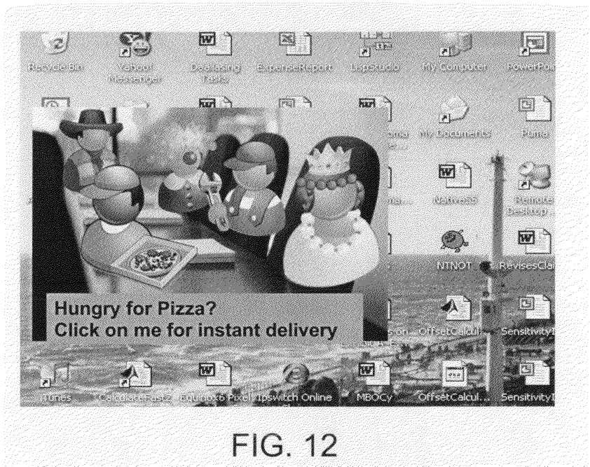

In FIG. 10, the new user has been moved to the virtual conference room, and foreground scaling has occurred to ensure this new user fits into the conference room representation. At this juncture the new user participant may be connected to the conference audio stream and textual chat session and be able to see and interact with the other user participants, who may be represented via avatars, still images, dynamic live video images, etc.

As indicated by FIG. 11, one of the earlier user participants in the conference session has expressed a desire for something to eat. This request may have been expressed textually, e.g., by the user typing, “I am hungry”, perhaps handwriting the words on a digitized tablet or the like, or audibly, perhaps by the user enunciating words such as “I am hungry”, or generating other sounds. The expressed desire may even be communicated visually by gestures that embodiments of the present invention detect as signifying hunger, perhaps the user rubbed his or her stomach to show hunger, a symbolic representation that is independent of the English or other language perhaps used during the chat session. A visual representation could include the hungry user participant pointing to an image of food, perhaps a picture of a pizza in a magazine adjacent that user. Indeed the manifestation of hunger may be inferred by system 100″ or 400, e.g., by execution of software routine 300, using a combination of different modes of information. For example, the user's pointing to a pizza and saying “I am hungry” can enable the present invention to infer that participant is hungry for pizza.

As shown by FIG. 12, according to embodiments of the present invention, a context sensitive ad, responsive to the mined information contents of chat conference, can be caused to appear on each user participant's video display. As noted, the information that is mined may include, without limitation, at least one of video information, audio information, typed or written information, gesture information, etc. In FIG. 12, a representation of a pizza delivery person appears in the background of the video screen, which ad may be caused to appear on some or all user participants display, caused to be enunciated audibly (e.g., words such as “Hungry for pizza? Click the (virtual) button appearing on your screen for instant delivery), or such words could be spelled out using text data. Understandably if the different user participants are in different geographic locations, clicking on the display button (or otherwise responding to the ad) will trigger an order for pizza to a pizza delivery service located near each user participant. Altered images of the user participants or altered avatars or icons could be shown to convey a response, e.g., user participants drooling at the sight of the displayed pizza delivery person.

Modifications and variations may be made to the disclosed embodiments without departing from the subject and spirit of the present invention as defined by the following claims.

What is claimed is:

1. A method to create at least one targeted content during a communications chat session between at least a first participant and a second participant, said first participant creating a first data stream that captures at least one characteristic of said first participant, the method including the following steps:
(a) extracting from said first data stream information to create a first representation of said at least one characteristic of said first participant;
(b) generating a first response appropriate to said at least one characteristic of said first participant, and
(c) communicating said first response to at least one of said first and said second participant,
wherein said first response includes at least one content targeted to be responsive to information obtained from said first data stream during said communications chat session.

2. The method of claim 1, wherein said first data stream includes at least one form of data selected from a group consisting of (i) a still video image of said first participant, (ii) a live dynamic video image of said first participant, (iii) an avatar created by said first participant, (iv) a sound made by said first participant during said communications chat session, (v) at least one word enunciated by said first participant during said communications chat session, (vi) at least one keyboard stroke entered by said first participant during said communications chat session, (vii) handwriting generated by said first participant during said communications chat session, and (viii) at least one video captured gesture made by said first participant during said communications chat session.

3. The method of claim 1, wherein said communications chat session includes a video chat session, said first data stream includes a first video stream, and said content targeted to be responsive includes at least one advertisement targeted to data mined during said video chat session.

4. The method of claim 1, wherein said communications chat session includes a video chat session in which at least part of said first data stream is captured in a manner selected from at least one of (i) using at least one camera system from which depth information is ascertainable, and (ii) using at least one time-of-flight camera system from which depth information is ascertainable.

5. The method of claim 3, wherein portions of said first video stream are captured using a RGB camera and a depth camera, and
step (a) includes using background substitution to extract from said first video stream said first foreground in said first scene; and
step (c) includes displaying said first foreground on at least one display viewable by at least one of said first and said second participant, said at least one display showing said first foreground superimposed on a computer controlled first background, said first background generatable even in absence of a video stream from said first participant;
wherein said computer controlled first background includes at least one content responsive to information obtained from said first video stream during said video chat session.

6. The method of claim 3, wherein communicating at step (c) includes at least one feature selected from a group consisting of (i) communicating said first response to at least one display remote from said first participant, (ii) communicating from said first video stream an extracted first foreground for viewing by at least a third participant in said chat session, (iii) communicating at least said first response via an Internet, (iv) communicating at least said first response via a network, (v) communicating at least said first response wirelessly, and (v) communicating said first response in a domain differing from an acquisition of said first response.

7. The method of claim 5, wherein at least said first foreground has at least one characteristic selected from a group consisting of (i) a transparency level greater than 0%, (ii) said first foreground includes at least one aspect identified by at least one participant in said chat session, (iii) said first foreground is representative of a customer support function, and (iv) a display of said first foreground is scalable independently of size of said computer controlled first background.

8. The method of claim 5, wherein said computer controlled background includes at least one of (i) an existing display less said first foreground, (ii) a document being presented by one of said first participant and said second participant, (iii) a virtual whiteboard used by one of said first participant and said second participant to create at least one visual image, (iv) a displayed advertisement including at least one participant-operable virtual selection button; (v) a static HTML page, (vi) a dynamic HTML page, (vii) a video stream, (viii) a database including at least one image, (ix) a database including social networking information, (x) a computer controlled background that is updatable in real-time responsive to at least one content of said chat session, (xi) said computer controlled background includes information of events occurring substantially contemporaneously with said chat session (xii) said computer controlled background includes information regarding at least one participant in said video chat, and (xxi) said computer controlled background is branded to display a brand of at least one of (I) a service provider, (II) an application provider, (III) a content provider, in which a branded said display is one of a static display and a dynamic display.

9. A system to create at least one targeted content during a communications chat session between at least a first participant and a second participant, said first participant creating a first data stream that captures at least one characteristic of said first participant, said system including:
means for extracting from said first data stream information to create a first representation of said at least one characteristic of said first participant;
means for generating a first response appropriate to said at least one characteristic of said first participant, and
means for communicating said first response to at least one of said first and said second participant;
wherein said first response includes at least one content targeted to be responsive to information obtained from said first data stream during said communications chat session.

10. The system of claim 9, wherein said first data stream includes at least one form of data selected from a group consisting of (i) a still video image of said first participant, (ii) a live dynamic video image of said first participant, (iii) an avatar created by said first participant, (iv) a sound made by said first participant during said communications chat session, (v) at least one word enunciated by said first participant during said communications chat session, (vi) at least one keyboard stroke entered by said first participant during said communications chat session, (vii) handwriting generated by said first participant during said communications chat session, and (viii) at least one video captured gesture made by said first participant during said communications chat session.

11. The system of claim 9, wherein said communications chat session includes a video chat session, and said content targeted to be responsive includes at least one advertisement targeted to data mined during said video chat session.

12. The system of claim 9, wherein said communications chat session includes a video chat session in which at least part of said first data stream is captured in a manner selected from at least one of (i) using at least one camera system from which depth information is ascertainable, and (ii) using at least one time-of-flight camera system from which depth information is ascertainable.

13. The system of claim 10, wherein said first data stream includes a first video stream wherein portions of said first video stream are captured using a RGB camera and a depth camera, and
said means for extracting uses background substitution to extract from said first video stream a first foreground in said first scene; and
said means for communicating includes displaying said first foreground on at least one display viewable by at least one of said first and said second participant, said at least one display showing said first foreground superimposed on a computer controlled first background, said first background generatable even in absence of a video stream from said first participant;
wherein said computer controlled first background includes at least one content responsive to information obtained from said first video stream during said video chat session.

14. The system of claim 9, wherein said means for communicating carries out least one feature selected from a group consisting of (i) communicating said first response to at least one display remote from said first participant, (ii) communicating said first foreground for viewing by at least a third participant in said chat session, (iii) communicating at least said first response via an Internet, (iv) communicating at least said first response via a network, (v) communicating at least said first response wirelessly, and (vi) communicating said first response in a domain differing from an acquisition of said first response.

15. The method of claim 13, wherein at least said first foreground has at least one characteristic selected from a group consisting of (i) a transparency level greater than 0%, (ii) said first foreground includes at least one aspect identified by at least one participant in said chat session, (iii) said first foreground is representative of a customer support function, and (iv) a display of said first foreground is scalable independently of size of said computer controlled first background.

16. The system of claim 13, wherein said computer controlled background includes at least one of (i) an existing display absent said first foreground, (ii) a document being presented by one of said first participant and said second participant, (iii) a virtual whiteboard used by one of said first participant and said second participant to create at least one visual image, (iv) a displayed advertisement including at least one participant-operable virtual selection button; (v) a static HTML page, (vi) a dynamic HTML page, (vii) a video stream, (viii) a database including at least one image, (ix) a database including social networking information, (x) a computer controlled background that is updatable in real-time responsive to at least one content of said chat session, (xi) said computer controlled background includes information of events occurring substantially contemporaneously with said chat session (xii) said computer controlled background includes information regarding at least one participant in said video chat, and (xxi) said computer controlled background is branded to display a brand of at least one of (I) a service provider, (II) an application provider, (III) a content provider, in which a branded said display is one of a static display and a dynamic display.

17. The system of claim 1, wherein at least one of said means for extracting, said means for generating, and said means for communicating is implemented using at least one of (i) hardware, and (ii) executable software.

18. A method to present an image that represents a participant in a video communications chat session that occurs between at least a first participant and a second participant, creating for said first participant using a three-dimensional camera system a first data stream that captures at least one video-derived characteristic of an imaged scene including said first participant, the method including the following steps:
(a) extracting from said first data stream a foreground image from said scene representing said first participant; and
(b) presenting the extracted said foreground image on a display of said second user, wherein said second user views said foreground image against a background this is a desktop for said second user.

19. The method of claim 18, wherein said foreground is less than 100% opaque.

20. The method of claim 18, wherein said foreground image is scalable relative to the desktop and includes at least one of (i) an actual image of said first participant, and (ii) an avatar representing said first participant.
